(19) United States
(12) Patent Application Publication
(10) Pub. No.: US 2024/0419563 A1
(43) Pub. Date: Dec. 19, 2024

(54) STATUS DISPLAY OF IMAGE FORMING APPARATUS USING POWER INPUT THROUGH WIRED INTERFACE

(71) Applicant: Hewlett-Packard Development Company, L.P., Spring, TX (US)

(72) Inventors: Suyong LEE, Seongnam Si (KR); Young Kang KONG, Seongnam Si (KR); Myung Won KIM, Seongnam Si (KR); Kiyoun KIM, Seongnam Si (KR)

(21) Appl. No.: 18/703,791

(22) PCT Filed: Oct. 4, 2022
(86) PCT No.: PCT/US2022/045600

§ 371 Date: Apr. 23, 2024

(30) Foreign Application Priority Data
Oct. 29, 2021 (KR) 10-2021-0146329

(51) Int. Cl. G06F 11/22; G06F 11/30; G06F 11/32

(52) U.S. Cl. CPC G06F 11/2284; G06F 11/3055; G06F 11/324

(57) ABSTRACT

An example image forming apparatus includes a main board having a processor, a power unit to provide driving power to the main board, a wired interface to connect with an external apparatus through a wired connection, a detection circuit to detect an operation status of the power unit, a display, and a processor. The processor, based on the power unit being detected to be in a non-operating status by the detection circuit in a state wherein a turn-on instruction was input, is to be provided with power from the external apparatus through the wired interface and is booted, and, based on the booting being completed, is to control the display to display a status of the power unit.

### BACKGROUND

An image forming apparatus may refer to an apparatus which prints printing data generated in a terminal apparatus like a computer on a printing medium such as paper. As examples of such an image forming apparatus, there may be copiers, printers, facsimiles, scanners, or multi-function peripherals (MFPs) which multiply implement functions of the aforementioned apparatuses through one apparatus, etc.

### BRIEF DESCRIPTION OF THE DRAWINGS

Various examples will be described below by referring to the following figures.

FIG. 1 is a block diagram illustrating a structure of an image forming apparatus according to an example;

FIG. 2 is a block diagram illustrating a more detailed structure of an image forming apparatus according to an example;

FIG. 3 is a diagram for illustrating a driving process of an image forming apparatus according to an example;

FIG. 4 is a circuit diagram of an image forming apparatus according to an example;

FIG. 5 is a diagram for illustrating a driving process of an image forming apparatus according to an example;

FIG. 6 is a circuit diagram of an image forming apparatus according to an example;

FIG. 7 is a flow chart for illustrating a method of displaying a status of an image forming apparatus according to an example;

FIGS. 8 and 9 are flow charts for illustrating methods of displaying a status of an image forming apparatus according to various examples; and

FIG. 10 is a diagram illustrating program codes stored in a non-transitory computer-readable recording medium according to an example.

### DETAILED DESCRIPTION

Examples that are described below are to promote an understanding of the disclosure. However, the disclosure may be implemented while being modified in various forms, unlike the examples described herein.

As terms used in this specification and the claims, general terms were selected, in consideration of the functions described in the disclosure. However, the terms may vary depending on legal or technical interpretation or emergence of new technologies.

In addition, in some cases, there are terms that were arbitrarily designated, and the meaning of such terms may be interpreted as defined in this specification, and if there is no specific definition of the terms, the terms may be interpreted based on the overall content of this specification and general technical knowledge in the art.

Further, in this specification, elements for explanation of each example of the disclosure are described, and thus elements are not necessarily limited thereto. Accordingly, some elements may be changed or omitted, or other elements may be added. Also, elements may be arranged to be dispersed in apparatuses independent from one another.

A description that one element is “connected to” another element should be interpreted to include both the case where the one element is directly connected to the other element, and the case where the one element is connected to the other element through still another element. Also, the description that an element “includes” another element does not mean that other elements are excluded, but rather that other elements may be further included, unless there is any specific description meaning the contrary.

In the description, the order of each operation should be understood in a nonrestrictive way, unless a preceding operation should necessarily be performed prior to a subsequent operation in a logical and temporal sense. That is, excluding an exceptional case as above, even if a process described as a subsequent operation is performed prior to a process described as a preceding operation, there would be no influence on the essence of the disclosure, and the scope of the disclosure should also be defined regardless of the orders of operations.

Hereinafter, examples will be described with reference to the accompanying drawings and the contents described in the accompanying drawings, but the disclosure is not restricted or limited by the examples.

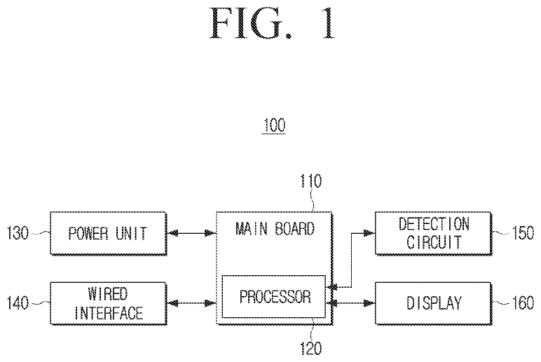

FIG. 1 is a block diagram illustrating a structure of an image forming apparatus according to an example.

Referring to FIG. 1, an image forming apparatus 100 may include a main board 110 having a processor 120, a power unit 130, a wired interface 140, a detection circuit 150, and a display 160.

The image forming apparatus 100 may perform various kinds of image forming jobs. As examples of such an image forming apparatus, there may be copiers, printers, facsimiles, or multi-function peripherals (MFPs) which multiply implement functions of the aforementioned apparatuses through one apparatus, etc., but the disclosure is not limited thereto.

Also, in this specification, “a user” may refer to a person who performs a manipulation related to an image forming job by using an image forming apparatus or an apparatus connected with the image forming apparatus via wire or wirelessly.

The main board 110 includes the processor 120. In an example, the main board 110 and the processor 120 may include semiconductor devices such as a memory (not shown), and the main board 110 may control an operation (e.g., operate the system) of the image forming apparatus 100. As an example, the main board 110 may use 3.3V as the system power. If the main board 110 is provided with power of 5V from the power unit 130, it may generate power of 3.3V by using a converter.

The processor 120 may control a function of the image forming apparatus 100. The processor 120 may be implemented as a central processing unit (CPU), an application-specific integrated circuit (ASIC), a system on chip (SoC), etc., but is not limited thereto. The processor 120 may perform various operations based on data or instructions stored in the memory (not shown) of the image forming apparatus 100. For example, the processor 120 may execute a program stored in the memory, read data stored in the memory, store new data in the memory, or the like.

If a turn-on instruction is input into the image forming apparatus 100, the processor 120 may be provided with power from the power unit 130 and the processor 120 may be booted. A turn-on instruction may include an instruction to start driving of the image forming apparatus 100, and the instruction may be input by a user. In an example, the turn-on instruction may be input by pushing a power button provided on the image forming apparatus 100, or a driving instruction may be input from an external apparatus connected with the image forming apparatus 100.

The power unit 130 is to provide power to the image forming apparatus 100. The power unit 130 may provide driving power to the main board 110 and may provide power to various kinds of units or devices for performing an image forming job in the image forming apparatus 100. According to an example, the power unit 130 may include a switching mode power supply (SMPS), and the SMPS may provide driving power to the main board 110 and other boards. Also, the power unit 130 may include a high voltage power supply (HVPS), and the HVPS may provide a high voltage to a developing unit, a charging unit, a transfer unit, etc. which use a high voltage in the image forming apparatus 100. In an example, the power unit 130 may convert alternating current (AC) power input through a power cable into direct current (DC) power, and provide the power to the main board 110.

The wired interface 140 is to connect an external apparatus to the image forming apparatus 100 via a wired connection, such as a cable. According to an example, the wired interface 140 may include a universal serial bus (USB) interface, and connect a personal computer (PC), which is an external apparatus, with the image forming apparatus 100 via a USB cable. The wired interface 140 may include a connector that is exposed on a surface (e.g., a rear surface, a side surface, etc.) of the image forming apparatus 100. The image forming apparatus 100 may be connected with an external apparatus through the wired interface 140 to communicate data, etc. with the external apparatus. Also, the image forming apparatus 100 may be provided with VBUS power (e.g., 5V) from an external apparatus connected to the wired interface 140. Alternatively, VBUS power may be input into the image forming apparatus 100 by connecting a subsidiary battery, etc. to the wired interface 140.

The detection circuit 150 is to detect an operation status of the power unit 130 of the image forming apparatus 100. According to an example, driving power may be provided from the power unit 130 to the main board 110. However, if the power of the power unit 130 is not provided to the main board 110 due to breakage or other inability of the power unit 130, etc., the detection circuit 150 may detect that the power unit 130 is unable to supply power. The detection circuit 150 may provide a signal to the processor 120 according to the status of the power unit 130. According to the status of the power unit 130 detected in the detection circuit 150, in case the power unit 130 is normal, the processor 120 may be booted by using the power provided from the power unit 130. In case power is not provided from the power unit 130, the processor 120 may be booted by being provided with power from an external apparatus through the wired interface 140.

The display 160 may be controlled by the processor 120 to display a status of the image forming apparatus 100. The display 160 may be implemented in various forms such as a liquid crystal display (LCD), an organic light emitting diode (OLED) display, a light emitting diode (LED) display, a plasma display panel (PDP), a quantum dot light-emitting diode (QLED) display, etc., but is not limited thereto.

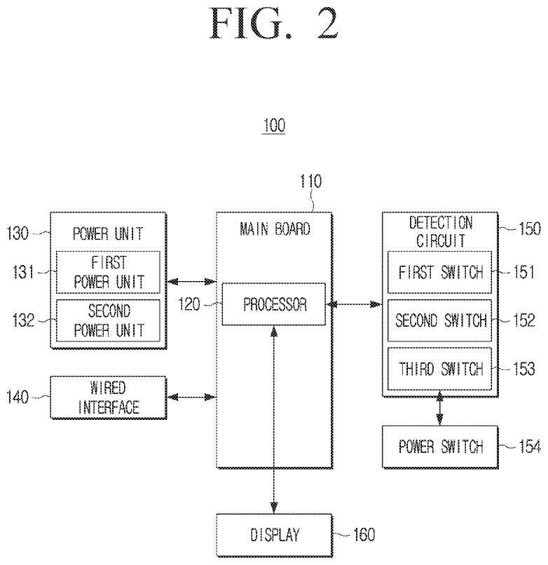

FIG. 2 is a block diagram illustrating a more detailed structure of an image forming apparatus according to an example.

Referring to FIG. 2, the power unit 130 may include a first power unit 131 and a second power unit 132, and the detection circuit 150 may include a first switch 151, a second switch 152, and a third switch 153. Also, the image forming apparatus 100 may further include a power switch 154.

The first power unit 131 may provide driving power to the main board 110, and the second power unit 132 may provide power to a driving unit included in the image forming apparatus 100. The driving unit may be a unit included in the image forming apparatus 100 to perform an image forming job, and may include a developing unit, a charging unit, a transfer unit, etc., but the disclosure is not limited thereto. The second power unit 132 may provide power to the driving unit which needs a high voltage. In that case, the second power unit 132 may provide a higher voltage than a voltage provided by the first power unit 131 to the image forming apparatus 100. The processor 120 may be booted by using the power provided from the first power unit 131.

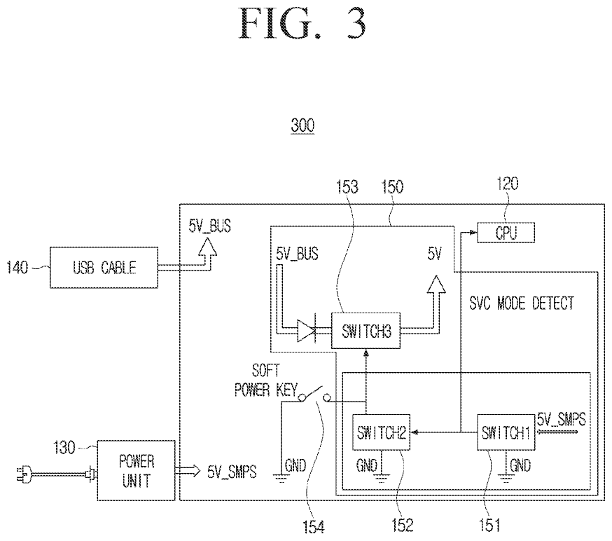

According to an example, the detection circuit 150 may detect a driving status of the power unit 130 by using the first to third switches 151-153. The first switch 151 may receive driving power from the power unit 130. The second switch 152 may be controlled according to an output of the first switch 151, and the third switch 153 may be controlled by turning-on/turning-off of the second switch 152. An example operating method will be described with reference to FIG. 3 to FIG. 6.

The power switch 154 may be turned on or turned off while being interlocked with a manipulation of a power key of the image forming apparatus 100. The power switch 154 may be connected to an input end of the third switch 153, and the operation of the third switch 153 may be controlled according to the turning-on/turning-off of the power switch 154. An example operating method will be described with reference to FIG. 3 to FIG. 6.

A user may input a turn-on instruction to drive the image forming apparatus 100. However, in case a component of the image forming apparatus 100 is unavailable (e.g., in a broken status), the image forming apparatus 100 may not be driven. According to an example, in case the power unit 130 of the image forming apparatus 100 is in a broken status, driving power is not provided to the main board 110, and accordingly, the processor 120 may not be booted, such that the image forming apparatus 100 may not be driven. Alternatively, in case the power unit 130 is in a normal status but the main board 110 itself is in a broken status, the processor 120 may not be booted even if driving power is input. In the past, based on the image forming apparatus 100 not being driven even by a turn-on instruction, the cause of breakage had to be determined while replacing the units of the image forming apparatus 100. In this case, unnecessary replacement of units may occur. Also, depending on the structure of the image forming apparatus 100, replacement of units may be difficult, or other breakage may occur while replacing a unit.

Accordingly, in examples of the disclosure, the wired interface 140 may be connected to an external apparatus, and the processor 120 may be booted by being provided with power from the external apparatus. In that case, a status (e.g., a breakage status) of the image forming apparatus 100 can thereby be determined.

FIG. 3 is a diagram for illustrating a driving process of an image forming apparatus according to an example.

Referring to FIG. 3, in a status in which the wired interface 140 is connected to an external apparatus through a wired connection such as a cable, a turn-on instruction may be input into the image forming apparatus 100. In an internal structure 300 of the image forming apparatus 100 according to an example, driving power of 5V may be provided through the power unit 130, and VBUS power of 5V may be provided through the wired interface 140. In the detection circuit 150, first to third switches 151, 152, 153 may be operated according to the power provision status of the power unit 130.

Based on the driving power being provided from the power unit 130 to the first switch 151, a first signal may be provided from the first switch 151 to the processor 120 and the second switch 152. Based on the first signal being input, the processor 120 may perform booting by using the power of the power unit 130. Based on the first signal being input, the second switch 152 may be in a turned-off status, and provide an off signal to the third switch 153. Based on the off signal being input, the third switch 153 may be in a turned-off status, and may not provide the power provided from the external apparatus through the wired interface 140 to the main board 110.

Based on the driving power not being provided from the power unit 130 to the first switch 151, a second signal may be provided from the first switch 151 to the processor 120 and the second switch 152. Based on the second signal being input, the processor 120 may perform booting by using the power input from the external apparatus through the wired interface 140. Based on the second signal being input, the second switch 152 may be in a turned-on status, and provide an on signal to the third switch 153. Based on the on signal being input, the third switch 153 may be in a turned-on status, and may provide the power provided from the external apparatus through the wired interface 140 to the main board 110. Detection of the operation of the power unit 130 by the detection circuit 150 is not limited to the aforementioned content, and whether the driving power of the power unit 130 was input may be determined by various methods.

In case the processor 120 performs booting by using the power provided from the external apparatus through the wired interface 140, based on the booting being completed, the processor 120 may control the display 160 to display a status (e.g., a breakage status) of the power unit 130. According to an example, the processor 120 may display a message on the display 160 to check the power cable, the power unit 130, etc. However, the disclosure is not limited thereto, and the processor 120 may turn on an LED of the display 160 and thereby enable the user to acknowledge the breakage status. Also, the processor 120 may notify the user by displaying an error message on a screen of the external apparatus connected with the image forming apparatus 100.

In case the processor 120 is not booted even though power is provided from the external apparatus through the wired interface 140, the user may identify the status, such as a breakage status, of the main board 110 itself.

If the power unit 130 operates by a turn-on instruction and provides driving power, the processor 120 may perform normal booting by using the driving power. Normal booting may refer to a general start of the operation of the image forming apparatus 100, and various units of the image forming apparatus 100 may be warmed up along with the booting of the processor 120. Warming-up of the various units may refer to an operation of rotating motors of the various units including motors, raising a temperature of a fixing unit, etc. but is not limited thereto.

In case the power unit 130 does not operate with respect to a turn-on instruction, the processor 120 may perform booting in a service mode by using the power provided from the external apparatus through the wired interface 140. The booting in the service mode may refer to a situation in which the various units of the image forming apparatus 100 remain in a non-warmed-up status, and booting is performed for the main board 110. Based on the booting being completed in the service mode, the processor 120 may control the display 160 to display a status, such as a breakage status, of the power unit 130.

The power switch 154 may be turned on or turned off while being interlocked with a manipulation of the power key arranged on the image forming apparatus 100 and may be connected to the input end of the third switch 153. Based on the power switch 154 being turned on, an on signal may be provided to the third switch 153. Based on the power switch 154 being turned off, a signal of the second switch 152 may be provided to the third switch 153, and the third switch 153 may operate according to the status of the second switch 152.

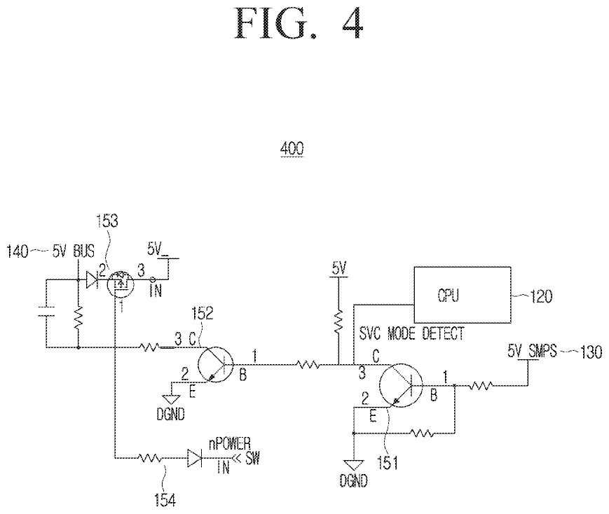

FIG. 4 is a circuit diagram of an image forming apparatus according to an example.

Referring to FIG. 4, a circuit diagram 400 includes each of the first and second switches 151, 152 implemented as a bipolar junction transistor (BJT) of an NPN type, and the third switch 153 implemented as a P channel field effect transistor (FET). However, the disclosure is not limited thereto.

Based on power of the power unit 130 being input into the first switch 151, a voltage of 0V is applied to the collector of the first switch 151, and accordingly, a first signal of 0V is input into the processor 120. As described above, based on the first signal being input, the processor 120 may perform normal booting.

Based on power of the power unit 130 not being input into the first switch 151, power of 5V provided from the external apparatus to the collector of the first switch 151 through the wired interface 140 is provided to the processor 120, and a second signal of 5V is input into the processor 120. As described above, based on the second signal being input, the processor 120 may perform booting in the service mode.

Based on power of the power unit 130 not being input into the first switch 151 and the first switch 151 being in a turned-off status, the second switch 152 may be in a turned-on status, and 0V may be applied to the collector of the second switch 152. As the second switch is put in a turned-on status, the third switch 153 is also in a turned-on status, and the third switch 153 may provide the power of 5V input through the wired interface 140 to the main board 110.

Based on the power key interlocked with the power switch 154 being pushed, the power input through the wired interface 140 may be temporarily provided to the main board 110. Here, in a normal status wherein the power of 5V is provided from the power unit 130 to the main board 110, the first switch 151 is turned on, and the second switch 152 is turned off. Accordingly, at the same time as release of the pushing of the power key, provision of the power input through the wired interface 140 is blocked, and the main board 110 performs booting by using the power input from the power unit 130.

However, in a status wherein the power of the power unit 130 is not provided to the main board 110 due to, for example, a breakage of the power unit 130, the first switch 151 is in a turned-off status and the second switch 152 is in a turned-on status, and thus the power input through the wired interface 140 may continuously be provided to the main board 110 in spite of the release of the pushing of the power key. Here, as the first switch 151 is in a turned-off status, the service mode signal is changed from 0V to 5V. The processor 120 may detect the service mode signal change from 0V to 5V and perform booting in the service mode.

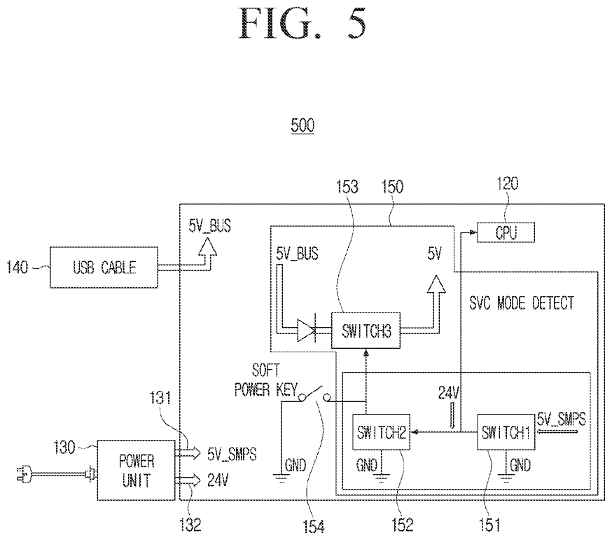

FIG. 5 is a diagram for illustrating a driving process of an image forming apparatus according to an example. Compared to FIG. 3, in a structure 500 in FIG. 5, the power unit 130 includes the first power unit 131 to provide driving power to the main board 110, and the second power unit 132 to provide power to a driving unit included in the image forming apparatus 100.

Based on a status wherein power is provided from the second power unit 132 to the driving unit of the image forming apparatus 100, but power is not provided from the first power unit 131 to the main board 110, the processor 120 may perform booting by using the power provided from the external apparatus through the wired interface 140. Based on the booting being completed, the processor 120 may control the display 160 to display a status (e.g., a breakage status) of the first power unit 131. Based on the booting not being completed, the user may identify a status such as a breakage status of the main board 110.

Based on a status wherein driving power of the main board 110 is provided from the first power unit 131, but power is not provided from the second power unit 132 to the driving unit of the image forming apparatus 100, the processor 120 may perform booting by using the power provided from the first power unit 131, and, based on the booting being completed, the processor 120 may control the display 160 to display status (e.g., a breakage status) of the second power unit 132.

Based on a status wherein power is not provided from either the first or the second power units 131, 132, the processor 120 may not perform booting using the power provided from the external apparatus through the wired interface 140. Accordingly, in a status wherein the power of the second power unit 132 was input, but not in a status wherein the power of the second power unit 132 was not input, booting of the processor 120 may be made to be performed by using the power provided from the external apparatus through the wired interface 140.

According to an example, the voltage of the first power unit 131 may be 5V and the voltage of the second power unit 132 may be 24V. In the first power unit 131 having a smaller voltage than the second power unit 132 having a relatively large voltage, breakages may occur more frequently. Accordingly, the breakage statuses of the power unit 130 may be mostly due to breakages of the first power unit 131, as there are fewer breakages of the second power unit 132. Accordingly, to identify whether the power cable of the power unit 130 is normally connected, booting of the processor 120 may be performed based on the premise that the power of the second power unit 132 is input.

Referring again to FIG. 3, even in a status wherein the power cable is not connected normally, booting of the processor 120 may be performed by using the power input from the external apparatus through the wired interface 140. In that case, the user may be made to misunderstand that there is a breakage status of the power unit 130 even though the power cable is connected abnormally.

Referring again to FIG. 5, in a status wherein the power cable is not connected, booting of the main board 110 is not made to be performed. Accordingly, the status may be made to match general knowledge for operating an apparatus in a situation in which a user operates the image forming apparatus 100.

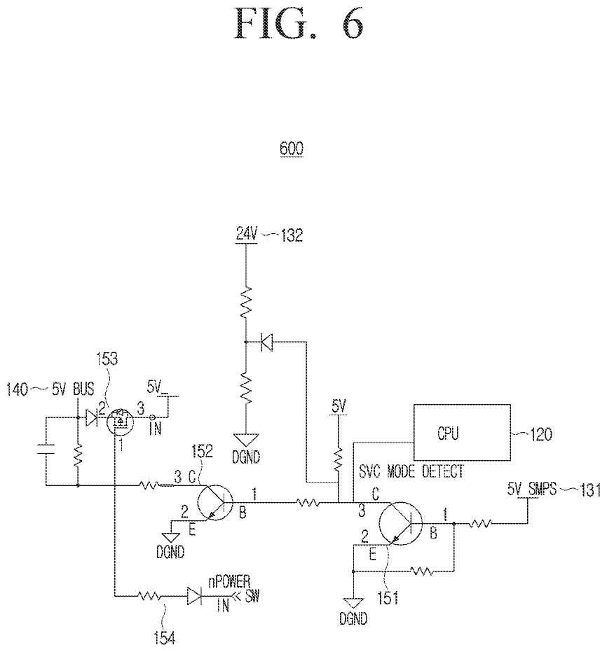

FIG. 6 is a circuit diagram of an image forming apparatus according to an example.

In a circuit diagram 600 of FIG. 6, regarding the operation of the second power unit 132, based on power not being input through the second power unit 132, an off signal is input into the second switch 152, and the third switch 153 is turned off. Accordingly, the power provided from the external apparatus through the wired interface 140 is not provided to the main board 110.

As descriptions regarding the operations of the first to third switches 151, 152, 153 and the power switch 154 were made above, overlapping explanation will be omitted.

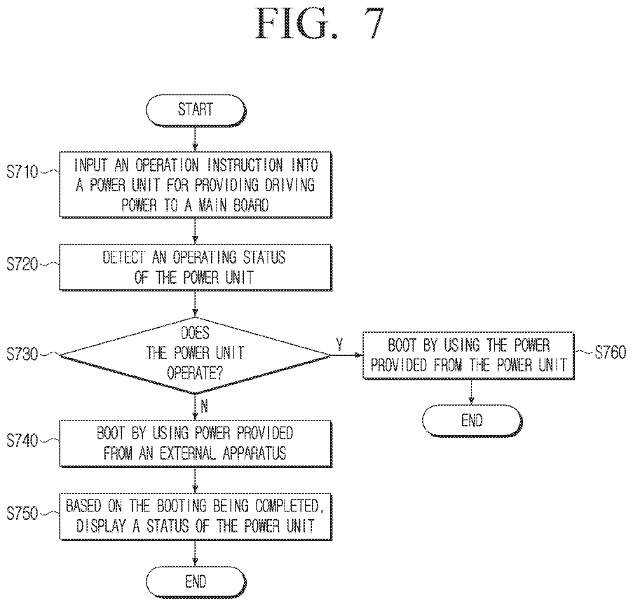

FIG. 7 is a flow chart for illustrating a method of displaying a status of an image forming apparatus according to an example.

According to FIG. 7, an example method of displaying a status of an image forming apparatus may include, based on a turn-on instruction being input, inputting an operation instruction into a power unit to provide driving power to a main board on which a processor is mounted in operation S710, detecting an operation status of the power unit in operation S720, based on the power unit being detected to be in a non-operating status in operation S730, booting by the processor by using power provided from an external apparatus connected with the image forming apparatus via wire in operation S740, and based on the booting being completed, displaying a status of the power unit in operation S750. According to an example, the method may further include, based on the power unit being detected to be in an operating status in operation S730, booting by using the power provided from the power unit in operation S760.

As a content related to a turn-on instruction, a content related to detecting an operating status of the power unit, a content related to booting by using power provided from an external apparatus connected via wire, and a content related to displaying a breakage status of the power unit were described in the aforementioned parts, overlapping explanation will be omitted.

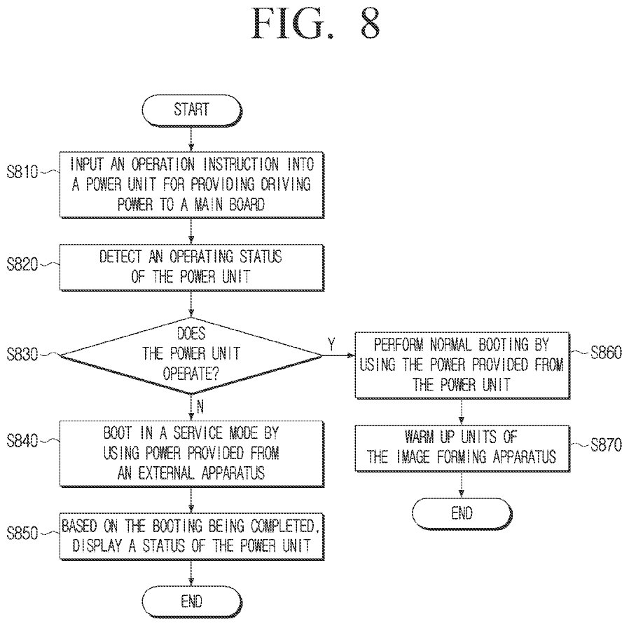

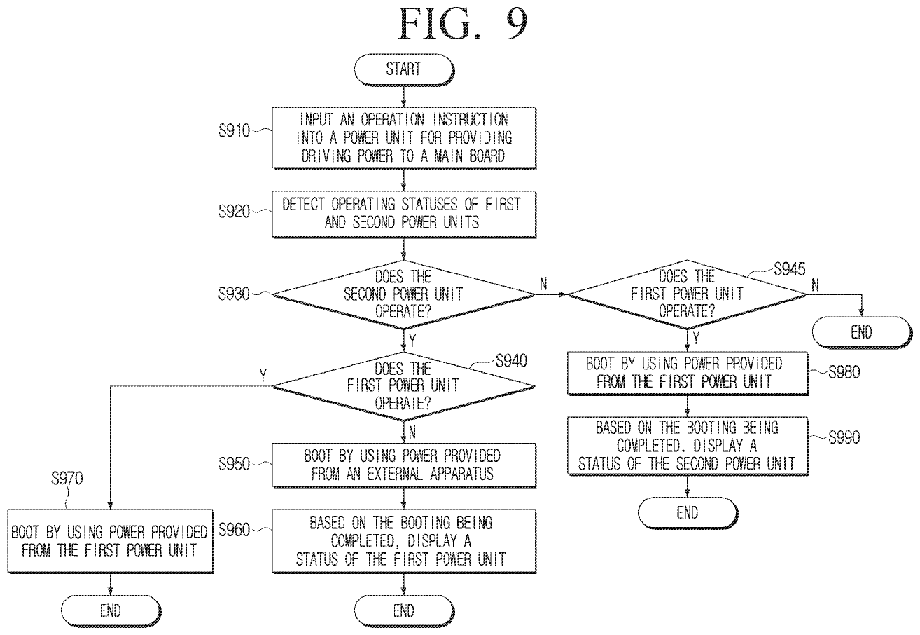

FIG. 8 and FIG. 9 are flow charts for illustrating methods of displaying a status of an image forming apparatus according to various examples. Because operations S810 and S910 and operations S820 and S920 are respectively similar to operations S710 and S720 that were described in the aforementioned parts, overlapping explanation will be omitted.

According to FIG. 8, an example method of displaying a status of an image forming apparatus may include, based on the power unit operating by the turn-on instruction and providing the driving power in operation S830, performing normal booting by using the driving power provided from the power unit in operation S860, and warming up various units of the image forming apparatus in operation S870. According to an example, the method may further include, based on the power unit not operating in operation S830, booting in a service mode by using the power provided from the external apparatus in operation S840, and, based on the booting being completed, displaying a status of the power unit in operation S850. As a content related to normal booting and a content related to a service mode were described in the aforementioned parts, overlapping explanation will be omitted.

An example method of displaying a status of an image forming apparatus may include operations of, a first switch being in a turned-on status based on the driving power being provided to the first switch from the power unit, and providing a first signal to a second switch and the processor, and the first switch being in a turned-off status based on the driving power not being provided to the first switch from the power unit, and providing a second signal to the second switch and the processor, the second switch being in a turned-off status based on the first signal being input into the second switch, and providing an off signal to a third switch, and the second switch being in a turned-on status based on the second signal being input into the second switch, and providing an on signal to the third switch, the third switch being in a turned-on status based on the on signal being input into the third switch, and providing the power provided from the external apparatus to the main board, and performing the normal booting based on the first signal being applied to the processor, and booting in the service mode based on the second signal being applied to the processor.

An example method of displaying a status of an image forming apparatus may include operations of, based on a power switch that is connected to an input end of the third switch being turned on, inputting an on signal into the third switch, and, based on the power switch being turned off, inputting a signal of the second switch into the third switch.

As contents related to the operations of the first to third switches and the power switch were described in the aforementioned parts, overlapping explanation will be omitted.

According to FIG. 9, an example method of displaying a status of an image forming apparatus may include operations of, based on power being provided to the driving unit from a second power unit providing power to the driving unit included in the image forming apparatus in operation S930, but power not being provided to the main board from a first power unit providing power to the main board in operation S940, booting by using the power provided from the external apparatus in operation S950, and, based on the booting being completed, displaying a status of the first power unit in operation S960.

According to an example, the method of displaying a status of an image forming apparatus may include operations of, based on power being provided to the driving unit from a second power unit providing power to the driving unit included in the image forming apparatus in operation S930, and power being provided to the main board from a first power unit providing power to the main board in operation S940, booting by using the power provided from the first power unit in operation S970.

According to an example, the method of displaying a status of an image forming apparatus may include operations of, based on power not being provided to the driving unit from the second power unit in operation S930, but the driving power being provided to the main board from the first power unit in operation S945, booting by using the power provided from the first power unit in operation S980, and based on the booting being completed, displaying a status of the second power unit in operation S990.

According to an example, the method of displaying a status of an image forming apparatus may include operations of, based on power not being provided from the second power unit in operation S930, and power not being provided from the first power unit in operation S945, not performing booting using the power provided from the external apparatus.

As a content related to the first and second power units, and a content related to displaying a status were described in the aforementioned parts, overlapping explanation will be omitted.

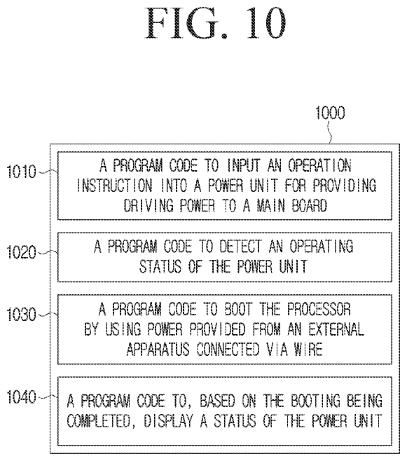

FIG. 10 is a diagram illustrating program codes stored in a non-transitory computer-readable recording medium according to an example.

Referring to FIG. 10, a non-transitory computer-readable recording medium 1000 may store program codes related to the aforementioned operations of the image forming apparatus. For example, the non-transitory computer-readable recording medium 1000 may store a program code 1010 to, based on a turn-on instruction being input, input an operation instruction into a power unit to provide driving power to a main board on which a processor is mounted, a program code 1020 to detect an operation status of the power unit, a program code 1030 to, based on the power unit being detected to be in a non-operating status, boot the processor by using power provided from an external apparatus connected with the image forming apparatus via wire, and a program code 1040 to, based on the booting being completed, display a status of the power unit. Each program code may be manufactured in program languages in various forms and recorded. Also, each program code may be combined as at least one program code and stored in the non-transitory computer-readable recording medium in the form of a computer readable instructions module.

Such a non-transitory computer-readable recording medium may include a read-only memory (ROM), a random-access memory (RAM), a flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, a magnetic tape, a floppy disk, a magneto-optical data storage apparatus, an optical data storage apparatus, a hard disk, a solid-state disk (SSD), and computer readable instructions, related data, data files, and data structures. Also, the non-transitory computer-readable recording medium may be any apparatus that can provide computer readable instructions, related data, data files, and data structures to a processor or a computer so that the processor or the computer can execute the instructions.

While examples of the disclosure have been shown and described, the disclosure is not so limited and it is apparent that various modifications can be made without departing from the gist of the disclosure as claimed by the appended claims, and such modifications are within the scope of the descriptions of the claims.

What is claimed is:

1. An image forming apparatus comprising:
a main board including a processor;
a power unit to provide driving power to the main board;
a wired interface to connect with an external apparatus through a wired connection;
a detection circuit to detect an operation status of the power unit; and
a display,
wherein the processor, based on the power unit being detected to be in a non-operating status by the detection circuit in a state wherein a turn-on instruction was input, is to be provided with power from the external apparatus through the wired interface and booted, and, based on the booting being completed, is to control the display to display a status of the power unit.

2. The image forming apparatus of claim 1, wherein the processor is to:
based on the power unit operating by the turn-on instruction and providing the driving power, perform normal booting by using the driving power and warm up units of the image forming apparatus, and
based on the power unit not operating, boot in a service mode by using the power provided from the external apparatus through the wired interface, wherein the service mode is a mode wherein the status of the power unit is displayed by driving the main board while leaving the units of the image forming apparatus in a non-warmed-up status.

3. The image forming apparatus of claim 2, wherein the detection circuit comprises:
a first switch to receive the driving power from the power unit;
a second switch controlled according to an output of the first switch; and
a third switch controlled to be turned on/turned off by the second switch,
wherein the first switch is in a turned-on status based on the driving power being provided from the power unit and is to provide a first signal to the second switch and the processor, and is in a turned-off status based on the driving power not being provided and is to provide a second signal to the second switch and the processor,
wherein the second switch is in a turned-off status based on the first switch being in a turned-on status and the first signal being input and is to provide an off signal to the third switch, and is in a turned-on status based on the first switch being in a turned-off status and the second signal being input and is to provide an on signal to the third switch,
wherein the third switch is to provide the power provided from the external apparatus to the main board based on being in a turned-on status by the signal of the second switch, and
wherein the processor is to perform the normal booting based on the first signal being applied, and is to perform booting in the service mode based on the second signal being applied.

4. The image forming apparatus of claim 3, further comprising:
a power switch that is connected to an input end of the third switch, and that is turned on or turned off while being interlocked with a manipulation of a power key arranged on the image forming apparatus,
wherein the third switch, based on the power switch being turned on, is to provide the power provided from the external apparatus to the main board, and based on the power switch being turned off, is to operate according to the status of the second switch.

5. The image forming apparatus of claim 1, wherein the power unit comprises:
a first power unit to provide driving power to the main board; and
a second power unit to provide power to a driving unit included in the image forming apparatus,
wherein the processor is to, based on being in a status wherein power is provided to the driving unit from the second power unit, but power is not provided to the main board from the first power unit, perform booting by using the power provided from the external apparatus, and
wherein the processor is to, based on the booting being completed, control the display to display a status of the first power unit.

6. The image forming apparatus of claim 5,
wherein the processor is to, based on being in a status wherein the driving power is provided from the first power unit, but power is not provided to the driving unit from the second power unit, perform booting by using the power provided from the first power unit, and
wherein the processor is to, based on the booting being completed, control the display to display a status of the second power unit.

7. The image forming apparatus of claim 6, wherein the processor, based on being in a status wherein power is not provided from either the first power unit or the second power unit, is not to perform booting using the power provided from the external apparatus.

8. A method of displaying a status of an image forming apparatus, the method comprising:
based on a turn-on instruction being input, inputting an operation instruction into a power unit for providing driving power to a main board on which a processor is mounted;
detecting an operation status of the power unit;
based on the power unit being detected to be in a non-operating status, booting by the processor by using power provided from an external apparatus connected with the image forming apparatus via wire; and
based on the booting being completed, displaying a status of the power unit.

9. The method of claim 8, further comprising:
based on the power unit operating by the turn-on instruction and providing the driving power, performing normal booting by using the driving power and warming up units of the image forming apparatus; and
based on the power unit not operating, booting in a service mode by using the power provided from the external apparatus,
wherein the service mode is a mode wherein the status of the power unit is displayed by driving the main board while leaving the units of the image forming apparatus in a non-warmed-up status.

10. The method of claim 9, further comprising:
switching a first switch to a turned-on status based on the driving power being provided to the first switch from the power unit, and providing a first signal to a second switch and the processor, and switching the first switch to a turned-off status based on the driving power not being provided to the first switch, and providing a second signal to the second switch and the processor;
switching the second switch to a turned-off status based on the first signal being input into the second switch, and providing an off signal to a third switch, and switching the second switch to a turned-on status based on the second signal being input into the second switch, and providing an on signal to the third switch;
switching the third switch to a turned-on status based on the on signal being input into the third switch, and providing the power provided from the external apparatus to the main board; and
performing the normal booting based on the first signal being applied to the processor and booting in the service mode based on the second signal being applied to the processor.

11. The method of claim 10, further comprising:
based on a power switch that is connected to an input end of the third switch being turned on, inputting an on signal into the third switch; and
based on the power switch being turned off, inputting a signal of the second switch into the third switch,
wherein the power switch is turned on or turned off while being interlocked with a manipulation of a power key arranged on the image forming apparatus.

12. The method of claim 8, further comprising:
based on power being provided to the driving unit from a second power unit providing power to the driving unit included in the image forming apparatus, but power not being provided to the main board from a first power unit providing power to the main board, booting by using the power provided from the external apparatus; and
based on the booting being completed, displaying a status of the first power unit.

13. The method of claim 12, further comprising:
based on the driving power being provided from the first power unit, but power not being provided to the driving unit from the second power unit, booting by using the power provided from the first power unit; and
based on the booting being completed, displaying a status of the second power unit.

14. The method of claim 13, further comprising:
based on power not being provided from either the first power unit or the second power unit, not performing booting using the power provided from the external apparatus.

15. A non-transitory recording medium storing program codes to execute a method of displaying a status of an image forming apparatus, the non-transitory recording medium comprising:
a program code to, based on a turn-on instruction being input, input an operation instruction into a power unit to provide driving power to a main board on which a processor is mounted;
a program code to detect an operation status of the power unit;
a program code to, based on the power unit being detected to be in a non-operating status, boot by the processor by using power provided from an external apparatus connected with the image forming apparatus via wire; and
a program code to, based on the booting being completed, display a status of the power unit.
